(19) United States
(12) Patent Application Publication
(10) Pub. No.: US 2006/0272304 A1
(43) Pub. Date: Dec. 7, 2006

(54) Air treatment apparatus and method of use thereof

(76) Inventor: John William Louis Schupp, Mechanicville, NY (US)

Correspondence Address: SCHMEISER, OLSEN & WATTS, 22 CENTURY HILL DRIVE, SUITE 302, LATHAM, NY, 12110, US

(21) Appl. No.: 11/145,205

(22) Filed: Jun. 3, 2005

(51) Int. Cl. B01D 46/10

(52) U.S. Cl. 55/501; 96/222

(57) ABSTRACT

An air treatment apparatus that affords the ability to treat air according to aroma preference and applicable air space with scented support structures being adaptably exposable to release variable portions of fragrance into an airflow, and a corresponding method of treating air through the use of the air treatment apparatus.

### BACKGROUND OF INVENTION

1. Technical Field

This invention relates generally to the treatment of air. More particularly, this invention provides for an adjustable aromatic air treatment apparatus for forced airflow filtration and a corresponding method of use thereof.

2. Related Art

Air pollutants and odors are a common nuisance and many known devices have been implemented to treat air. In this regard, common air treatment devices have, in general, provided air filters to remove pollutants and odors from the air. Moreover, known air treatment devices have incorporated aromatic resources to deliver fragrances to the treated air. Such typical air treatment devices deliver aromas via scented materials positioned with an air filter to release fragrance into an airflow encountering the treatment device. The scented materials often require heat activation. Additionally, the scented materials are often positioned with the air filter by the use of after market applications of aromatic gels, scented installable packets, or adhesive fragrant strips. Furthermore, common air treatment devices utilize scented support structures integral with the air filter to deliver fragrance into the air while supporting the air filter as it engages the airflow. However, the past devices and related methods for air treatment do not provide for coordination of the useable life of the air filter with the life of aromatic delivery pertinent to the air treatment device while affording operational aroma preference according to the volume of air to be treated.

Accordingly, there is a need for an improved air treatment apparatus that affords the ability to treat air according to aroma preference and applicable air space with scented support structures being adaptably exposable to release variable portions of fragrance into an airflow, and a corresponding method of treating air through the use of the air treatment apparatus.

### SUMMARY OF INVENTION

The present invention is directed to an air treatment apparatus that offers improved operability.

A first general aspect of the invention provides for a scented air filtration apparatus comprising an external frame, an air filter mounted in the frame, and a grid structure operating with the frame to support the air filter, wherein at least a portion of the grid structure contains aromatic material masked by removable cover elements.

A second general aspect of the invention provides for an aromatic treatment apparatus for forced airflow filtration comprising an air filter, an external frame retaining the periphery of the air filter, and a scented planar panel member supporting the air filter in conjunction with the external frame, wherein the scented planar panel member is configured to facilitate variably apportioned aromatic treatment of an airflow.

A third general aspect of the invention provides for a method of treating air comprising the steps of generating a forced airflow, providing an aromatic treatment apparatus for treatment of the forced airflow, the apparatus having an air filter, an external frame retaining the periphery of the air filter, and a grid structure operating with the external frame to support the air filter, wherein at least a portion of the grid structure contains aromatic material masked by removable cover elements, filtering air by passing the forced airflow through the air filter, introducing a preferred amount of aroma into the air by unmasking an aromatic portion of the grid structure through removal of a cover element according to a corresponding volume of airspace through which the airflow to be treated circulates, and removing additional cover elements to unmask additional portions of aromatic material periodically throughout a useable life of the aromatic treatment apparatus to maintain a preferred amount of aroma of the air.

A fourth general aspect of the invention provides for a method of treating air comprising the steps of generating an airflow, providing a scented air filtration apparatus having an external frame, an air filter mounted in the external frame, and a scented planar panel member supporting the air filter in conjunction with the external frame, wherein the scented planar panel member is configured to facilitate variably apportioned aromatic treatment of the airflow, filtering the airflow by passing the airflow through the air filter, scenting the airflow according to aroma preference in relation to the volume of space through which the airflow circulates by variably apportioning the aromatic treatment of the airflow, and adjusting the variable apportionment of aromatic treatment of the airflow throughout the useable life of the scented air filtration apparatus to sustain the aroma preference of the airflow.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a cut-away perspective view of an embodiment of an air treatment apparatus, in accordance with the present invention;

FIG. 2 depicts a cut-away perspective view of a portion of the embodiment of an air treatment apparatus as depicted in FIG. 1, and in accordance with the present invention;

FIG. 3 depicts a perspective view of another embodiment of an air treatment apparatus, in accordance with the present invention; and,

FIG. 4 depicts a perspective view of yet another embodiment of an air treatment apparatus, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

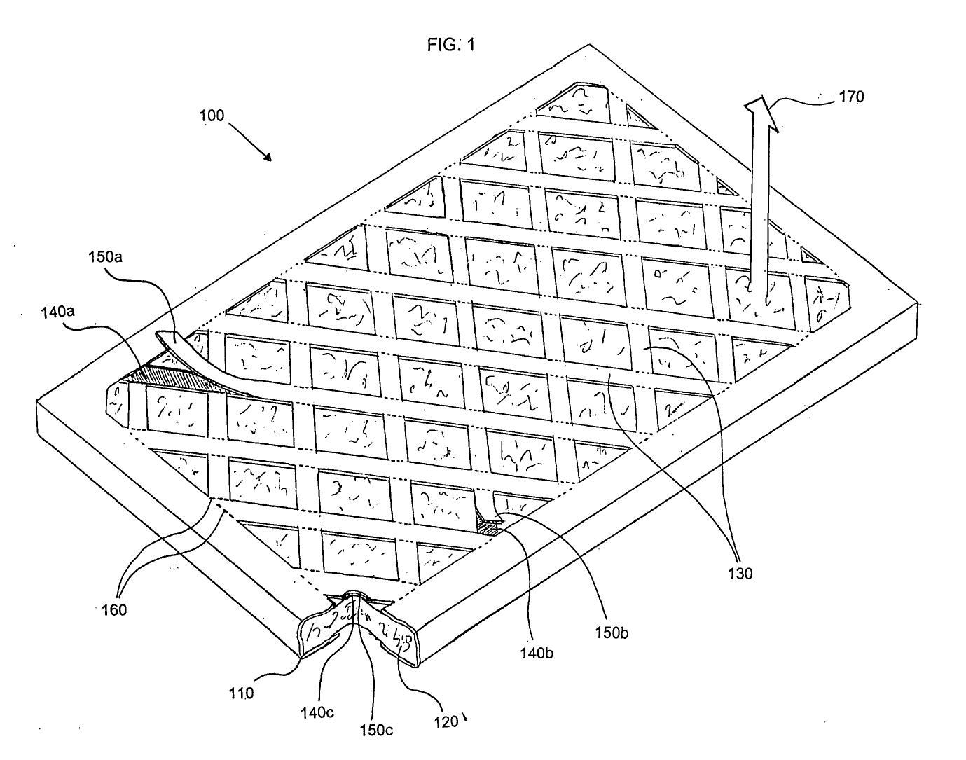

Referring to the drawings, FIG. 1 depicts a cut-away perspective view of an embodiment of an air treatment apparatus 100, such as a scented air filtration apparatus, in accordance with the present invention. The air treatment apparatus 100 may have an external frame 110 retaining the periphery of an air filter 120 mounted in the external frame 110. The external frame 110 may be formed of rigid or semi-rigid materials to provide shape and support for the air filter 120. The external frame 110 may be any shape pertinent to the use of an air treatment device 100. As such, the external frame 110 may be dimensioned to fit standard forced air furnace air filter housings and/or other similar forced air treatment system components. Additionally, various shapes, such as circular or polygonal dimensions, may correspond to the external frame 110 thereby allowing the air treatment device to be efficiently positioned for air treatment. One embodiment of the external frame 110, as depicted in the cut-away portion of FIG. 1, may be configured with a U-shaped cross-sectional opening to retain the outer edge of the air filter 120. However, other external frame 110 cross-sectional configurations, adaptable within the art and/or which provide support for the air filter 120, may be utilized to accomplish the objectives of the present invention. The external frame 110 may be formed of materials such as metal(s), metal alloy(s), wood(s), plastic(s), fiberglass, composite polymeric materials, hard rubber, glues, card-board or other pulpwood materials and/or other like materials and/or combinations thereof.

Referring further to FIG. 1, an embodiment of an air treatment apparatus 100 may include an air filter 120. The air filter 120 may be configured to filter pollutants and/or odors from air. An embodiment of the air filter 120 may comprise a pad of air-permeable/porous fibrous filtering material having a peripheral edge bordered by and/or mounted in the external frame 110. The air filter 120 may include an odor barrier composition designed to filter out unwanted odors. However, embodiments of the air treatment apparatus 100 may employ air filter 120 embodiments having different configurations and/or different physical compositions, but still capable of filtering air and working in cooperation with embodiments of the air treatment apparatus 100 of the present invention. Those skilled in the art should recognize that the air filter 120 may be designed to comply with various health regulations and/or standards. Moreover, various embodiments of the air filter 120 may be designed to function with various levels of filtration performance. Furthermore, embodiments of the air filter 120 may be designed to have varying useable life-spans of health and/or efficient filtration capability.

Referring still further to FIG. 1, an embodiment of an air treatment apparatus 100 may include a grid structure 130, operating with the external frame 110 to support the air filter 120. The grid structure 130 may be a planar panel member configured to support the air filter 120 in conjunction with the external frame 110. In an embodiment of the air treatment apparatus 100, the grid structure 130 may be integral with the external frame 110 and may serve, with the external frame 110, to shore up the air filter 120 during air treatment by the air treatment apparatus 100. The shape of the grid structure 130 may be substantially planar and may substantially span the air filter 120 as mounted in the external frame 110. However, it should be recognized that embodiments of the grid structure 130 may have curvature if the corresponding air filter 120 composes a spherical or elliptical plane or the like when utilized with an embodiment of an air treatment device 100 of the present invention. The shape of the grid, lattice, or network of supportive members of the grid structure 130 may vary. For example, an embodiment of the grid structure 130 may have criss-crossed diagonal members operably attached to the external frame 110 and spanning a planar surface of the air filter 120. It should be appreciated that embodiments of the air treatment apparatus 100 may incorporate two grid structures 130 positioned on either planar surface of an applicable air filter 120 and functional with an external frame 110 to support the air filter 120.

The planar panel member, or grid structure 130, may be scented. The scenting of the grid structure 130 may be accomplished by coating, spraying, dipping, blending, emulsifying, co-extruding, and/or impregnating the grid structure 130 with aromatic materials 140 and/or other like ways of providing fragrant material to the body of the grid structure 130. The aromatic material incorporated on the grid structure 130 may have a fragrant lifespan when exposed to air. Further, the scented planar panel member or grid structure 130 may be configured to facilitate variably apportioned aromatic treatment of air, such as the air comprising airflow 170 depicted in FIG. 1. Accordingly, embodiments of the grid structure 130 may contain aromatic material 140 masked by removable cover elements 150 or removable shields. The aromatic material 140 may correspond to a variety of scents. For example the material 140 may have a floral fragrance, a citrus fragrance, a mint fragrance, or other similar smell attributable thereto. The covering of the aromatic material 140 may act to prolong the fragrant lifespan of the scented material because the removable cover elements 150a-c, when in place on the grid structure 130, may shield the aromatic material 140a-c from the surrounding air preventing the dispersal of the aromatic material 140a-c into the air. Moreover, the removable cover elements 150 may act to veil or shroud the scent of the aromatic materials 140. Thus, a user of the air treatment apparatus 100 may introduce a preferred amount or apportionment of aroma into the air by unmasking an aromatic portion of the grid structure 130 through removal of the cover elements, such as cover elements 150a-c. The user may thereby scent the air according to aroma preference corresponding with, and in relation to, the volume of space through which the airflow 170 circulates. Hence, if a user prefers to treat an airflow 170, circulating within a particular volume of air space corresponding to a building or other structure having a particular square footage, the user may take away as many removable cover elements 150 from the grid structure 130 as necessary to achieve a preferred aroma. If the user desires to increase the potency of the scent of the circulating airflow 170, the user may remove additional removable cover elements 150 to expose more aromatic material 140, thereby allowing the additional exposed aromatic material 140 to disperse into the airflow 170 and increase the potency of the fragrance within the particular air space. Furthermore, a user may also achieve the same desired aroma while treating a larger volume of air as compared with a smaller volume of air by merely increasing the exposure of aromatic material 140 with the air by removing additional removable cover elements 150. Thus the air treatment apparatus 100 provides a user with an ability to adjust aroma potency according to user preference and without limitation by the volume of air space to be treated.

A user may also adjust the variable apportionment of aromatic treatment of an airflow 170, throughout the useable life of a scented air filtration apparatus 100 to sustain the preferred aroma of the air. Accordingly, as needed, a user may remove additional cover elements 150 to unmask additional portions of aromatic material 140 periodically throughout the useable life of the air treatment apparatus 100 to maintain a preferred aroma of the air. The removable cover elements 150 may be comprised of thin sticky strips, adhesive casings, detachable sheeting, tape, re-fastenable layer components, or other like members capable of being removably positioned over the aromatic material 140 incorporated with the grid structure 130. The removable cover elements 150 should be configured to substantially prevent the aromatic material from dispersing into surrounding air when the cover elements 150 are positioned over the aromatic material 140 incorporated with the grid structure 130. In addition, the removable cover elements 150 should prevent external odors from contaminating, weakening or mixing with the aromatic material 140.

Furthermore, the removable cover elements 150 may be segmented and separable. In an embodiment of an air treatment apparatus 100 the removable cover elements 150 may include perforations 160 allowing a user to tear and separate the elements segment by segment. Those having relevant artful skill will appreciate that the removable cover elements 150 may be segmented and separable in other ways besides perforation 160 and tearing, as long as the cover elements 150 may be removed in accordance with the inventive nature of an air treatment apparatus 100. Thus, if a user prefers to scent the volume of air related to the airflow 170 to a particular level of scented potency, the user can remove as many segments of the removable cover elements 150 as is necessary to obtain the desired potency. However, if the user desires to treat the air with an even more potent scent, the user can remove additional segments of the removable cover elements 150 to expose more aromatic material 140 and introduce more scent to the volume of air being treated. Moreover, in an embodiment of a scented air filtration apparatus 100, the removable cover elements 150 may be segmented in conformance with the lattice pattern of the grid structure 130.

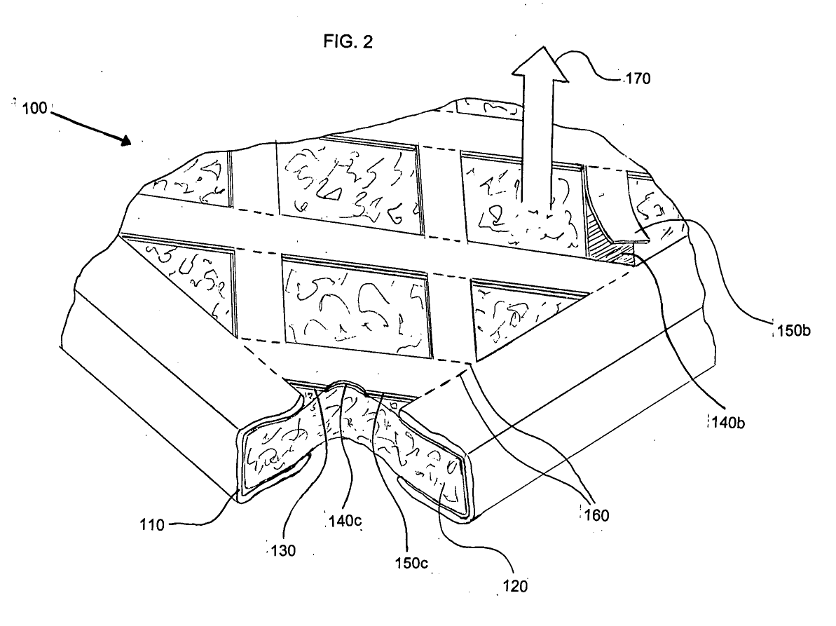

With continued reference to the drawings, FIG. 2 depicts a perspective view of a portion of the embodiment of an air treatment apparatus 100, in accordance with the present invention. To help facilitate efficient scented air filtration, the aromatic material 140 pertinent to the air treatment apparatus 100 may remain shielded by the removable cover elements 150 and/or the grid structure 130. For example, as shown, aromatic material 140c is sandwiched between removable cover element 150c and a portion of the grid structure 130. When the aromatic material 140 is masked by the removable cover elements 150 and/or the grid structure 130 it is protected from contact with the air flow 170. Accordingly, the scent may only be inserted into the airflow 170 when the removable cover elements 150 are disconnected from the grid structure 130 and taken away, thereby exposing the aromatic material 140 to the airflow 170. The airflow 170 may then acquire a fragrance as the aromatic material 140 is exposed and released into the airflow 170. Those skilled in the art should appreciate that various means may be utilized to conceal the aromatic material 140. For example, if the aromatic material is merely coated, sprayed, painted or otherwise applied to one side of a portion of the grid structure 130, then that side may be jacketed by removable cover elements 140; or, if the aromatic material 140 is impregnated into the grid structure 130 and/or the grid structure 130 is dipped into the aromatic material 140 or other methods are used to apply the aromatic material 140 such that the material permeates the body of the grid structure 130, then the body of the grid structure 130 should be covered in some way to prevent the aromatic material 130 from exposure to air. For, example, a substantial portion of a fragrantly permeated grid structure 130 may be sheathed by either the removable cover elements 150 or some other covering fixably attachable to the grid structure 130 to prevent unwanted introduction of scent to the airflow 170. Those in the art should recognize that substances used to mask the aromatic material 140 may be compatible for contact with the air filter 120.

Masking the aromatic material 140 protects the material from absorbing unwanted odors. Additionally, shielding the aromatic material 140 on the grid structure 130 preserves the aromatic life span of an air treatment apparatus 100. Hence, the aromatic treatment of the airflow 170 may be variably apportioned as to temporal dispersion of scent and/or the potency of fragrance because the grid structure 130 is configured to only release aromatic material into the airflow 170 as a user directs it through preferred removal of cover elements 150.

With further reference to FIGS. 1-2, an embodiment of an air treatment apparatus 100 may be mass manufactured in ways similar to typical air filtration devices such as forced air furnace filters. Mass manufacturing of an aromatic treatment apparatus 100, such as a scented air filtration apparatus, may eliminate the necessity of an extra step of performing an aftermarket modification to a typical air filtration device in order to achieve scented air treatment. Moreover, an embodiment of an aromatic air treatment apparatus 100 may be readily adaptable with standard air treatment system designs. In this regard, a user can obtain an aromatic air treatment apparatus 100, such as a scented air filtration apparatus, in ways similar to the common ways of obtaining typical air filtration devices. Furthermore, the aromatic air treatment apparatus 100, may function, fit, work and perform with standard furnaces, air conditioning units, and/or other similar forced airflow systems and components. For example, the aromatic material 140 may render available fragrance, when exposed, regardless of the temperature of the air comprising airflow 170. Thus, one can utilize a scented air filtration apparatus 100 in standard home/commercial use and obtain the benefit of air filtration, odor removal, and aromatic treatment. In addition, a user can install and remove a scented air filtration device 100 in ways similar to those of common air treatment devices. This convenience and adaptability with typical forced air treatment systems may allow a user to readily utilize the scented air filtration apparatus 100 and easily control the aromatic treatment of a particular volume of air according to preference.

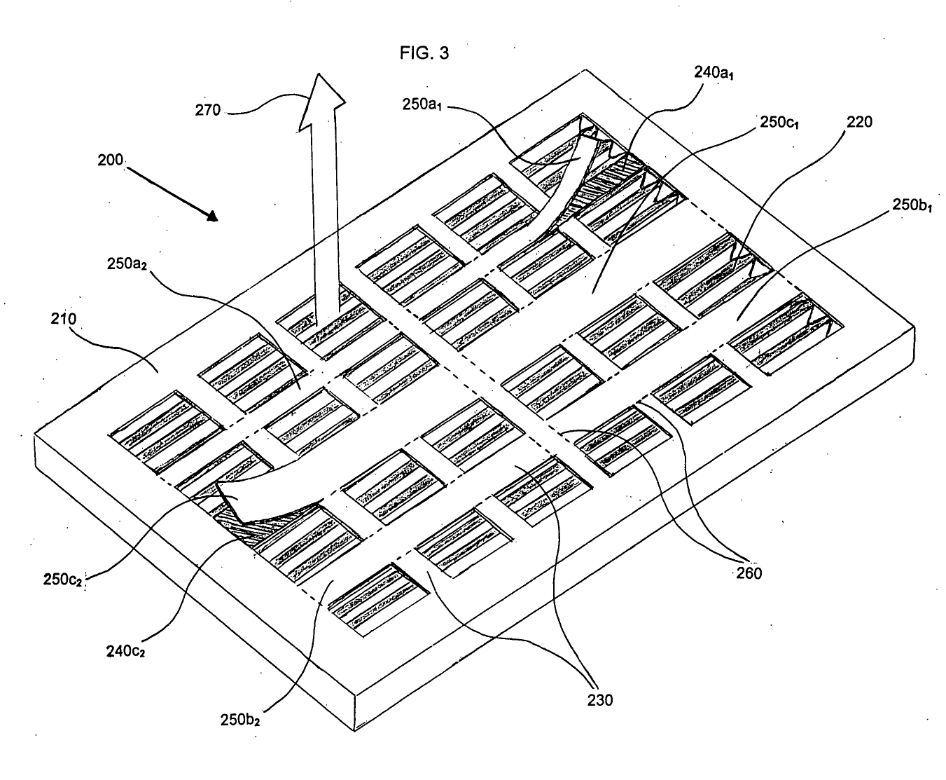

With additional reference to the drawings, FIG. 3 depicts a perspective view of another embodiment of an air treatment apparatus 200, in accordance with the present invention. The aromatic treatment apparatus 200, such as a scented air filtration apparatus, may have an external frame 210 retaining the periphery of an air filter 220 mounted in the external frame 210. The external frame may be formed of rigid or semi-rigid materials to provide shape and support for the air filter 220 and may be dimensioned to fit standard forced air treatment system components. The external frame 210 may be configured to retain the outer edge of the air filter 220. The air filter 220 may be configured to filter pollutants and/or odors from air. An embodiment of the air filter 220, as depicted in FIG. 3, may be a corrugated sheet of air-permeable/porous fibrous filtering material having a peripheral edge bordered by and/or mounted in the external frame 210. However, embodiments of the air treatment apparatus 200 may employ different air filter 220 embodiments having different configurations and/or different physical compositions, but still capable of filtering air and working in cooperation with embodiments of the aromatic treatment apparatus 200 of the present invention. Various embodiments of the air filter 220 may be designed to function with various levels of filtration performance and to have varying useable life-spans of health and/or efficient filtration capability.

Referring still to FIG. 3, an embodiment of an aromatic treatment apparatus 200, such as a scented air filtration apparatus, may include a grid structure 230, operating with the external frame 210 to support the air filter 220. The grid structure 230 may be a planar panel member configured to support the air filter 220 in conjunction with the external frame 210. In an embodiment of the air treatment apparatus 200, the grid structure 230 may be integral with the external frame 210 and may serve, with the external frame 210, to support the air filter 220 during air treatment. The shape of the grid structure 230 may be substantially planar and may substantially span the air filter 220 as mounted in the external frame 210. The shape of the grid, lattice, or network of supportive members of the grid structure 230 may vary. For example, an embodiment of the grid structure 230 may have members of variable width operably attached to the external frame 210 and spanning a planar surface of the air filter 220. It should be appreciated that embodiments of the air treatment apparatus 200 may incorporate two grid structures 230 positioned on either planar surface of an applicable air filter 220 and functional with an external frame 210 to support the air filter 220.

The planar panel member, or grid structure 230, may be scented and the scenting of the grid structure 230 may be accomplished by a variety ways of providing fragrant material to the body of the grid structure 230, in accordance with the inventive nature of the scented air filter apparatus 200. Additionally, the scented planar panel member or grid structure 230 may be configured to facilitate variably apportioned aromatic treatment of air, such as the air comprising airflow 270. Aromatic material 240 incorporated with the grid structure 230 may be masked by removable cover elements 250 or shields. The aromatic material 240 may correspond to a variety of scents. When the removable cover elements, such as elements 250a-c are in placed on the grid structure 130, the elements 250a-c may shield the aromatic material 240a-c from the surrounding air preventing the dispersal of the aromatic material 240a-c into the air. A user of the air treatment apparatus 200 may introduce a preferred amount or apportionment of aroma into the air by unmasking an aromatic portion of the grid structure 230 through removal of the shield-like cover elements, such as cover elements 250a-c. The user may thereby scent the air according to aroma preference corresponding with, and in relation to, the volume of space (possibly attributable to structural square footage) through which the airflow 270 circulates. Hence, if a user prefers to treat an airflow, such as airflow 270, circulating within a particular volume of air space corresponding to a building or other structure having a particular square footage, the user may take away as many removable cover elements 250 from the grid structure 230 as necessary to achieve a preferred aroma. In an embodiment of an aromatic air treatment apparatus 200 the removable cover elements 250 may be segmented and separable. Perforations 260 may be one way to make possible the segmentation and separation of the removable cover elements 250, but other comparable means may be used to split apart various portions of the removable cover elements 250.

To assist a user in discerning how many cover element(s) 250 to separate and remove from the grid structure 230 in order to expose enough aromatic material 240 to obtain a particular level of environmental fragrance, the removable cover elements 250 may be segmented in varying dimensions corresponding to variably dimensioned portions of the grid structure 230. Hence, if a user prefers to scent an approximate volume of air generally related to a building structure having a certain square footage, then the user can remove a segment, or segments, of the removable cover elements 250 corresponding to predetermined indicia dimensionally related to the grid structure 230 and corresponding to the particular square footage to be treated. For example, the embodiment of the air treatment apparatus 200 may be configured with a segmented removable cover element 250a₁ masking a portion of the grid structure 230, such that removal of the cover element 250a₁ exposes enough aromatic material 240a₁ to aromatically treat a volume of air pertinent to a 500 square foot structure. Moreover, the embodiment of the air treatment apparatus 200 may also be configured with a segmented removable cover element 250b₁ masking a portion of the grid structure 230, such that removal of the cover element 250b₁ exposes enough aromatic material 240b₁ (not shown, but understood to be present under the protective removable cover element 250b₁) to aromatically treat a volume of air pertinent to a 1000 square foot structure. Further, the embodiment of the air treatment apparatus 200 may be configured with a segmented removable cover element 250c₂ masking a portion of the grid structure 230, such that removal of the cover element 250c₂ exposes enough aromatic material 240c₂ to aromatically treat a volume of air pertinent to a 1500 square foot structure. Accordingly, a user may reference the predetermined indicia to dictate how to possibly aromatically treat the air of a 2000 square foot structure by segmenting and removing cover elements 250a₁ and 250c₂, thereby exposing corresponding portions of aromatic material 240a₁ and 240c₂ to the airflow 270. It should be appreciated that the same treatment indicia pertinent to the scented air filtration apparatus 200 may be utilized through segmentation and removal of cover elements 240a₂ and 240c₁ or removal of cover elements 240b₁ and 240b₂, as any of the three removal combinations relate to predetermined suggested treatment indicia pertaining to a 2000 square foot structure. However, if the user ultimately desires to treat the air with a stronger fragrance than the scent pertinent to the indicia, then the user can remove additional portions of the removable cover elements 250 to expose more aromatic material 240 and introduce more scent to the volume of air being treated.

In an embodiment of a scented air filtration apparatus 200, the removable cover elements 250 may be segmented in conformance with the lattice pattern of the grid structure 230. For example, removable cover element 250a may be apportioned into two segments 250a₁ and 250a₂. Likewise, dimensionally larger removable cover elements 250b and 250c may be apportioned in a similar manner. In this way, a user may be afforded opportunity to expose varying amounts of aromatic material 240 to the airflow 270 circulating through a related air volume. Thus the aromatic air treatment apparatus 200 provides a user with an ability to adjust aroma potency according to user preference and without limitation by the volume of air space to be treated.

A user may also adjust the variable apportionment of aromatic treatment of an airflow, such as airflow 270, throughout the useable life of a scented air filtration apparatus 200 to sustain the preferred aroma of the air. Accordingly, as needed, a user may remove additional cover elements 250 to unmask additional portions of aromatic material 240 periodically throughout the useable life of the aromatic air treatment apparatus 200 to maintain a preferred aroma of the air. Temporal indicia may assist a user in determining when to take away additional removable cover elements 250 and how much aromatic material 240 to unmask. The removable cover elements 250 should be configured to substantially prevent the aromatic material 240 from dispersing into surrounding air when the cover elements 250 are positioned over the aromatic material 240 incorporated with the grid structure 230. In addition, the removable cover elements 250 should prevent external odors from contaminating, weakening or mixing with the aromatic material 240.

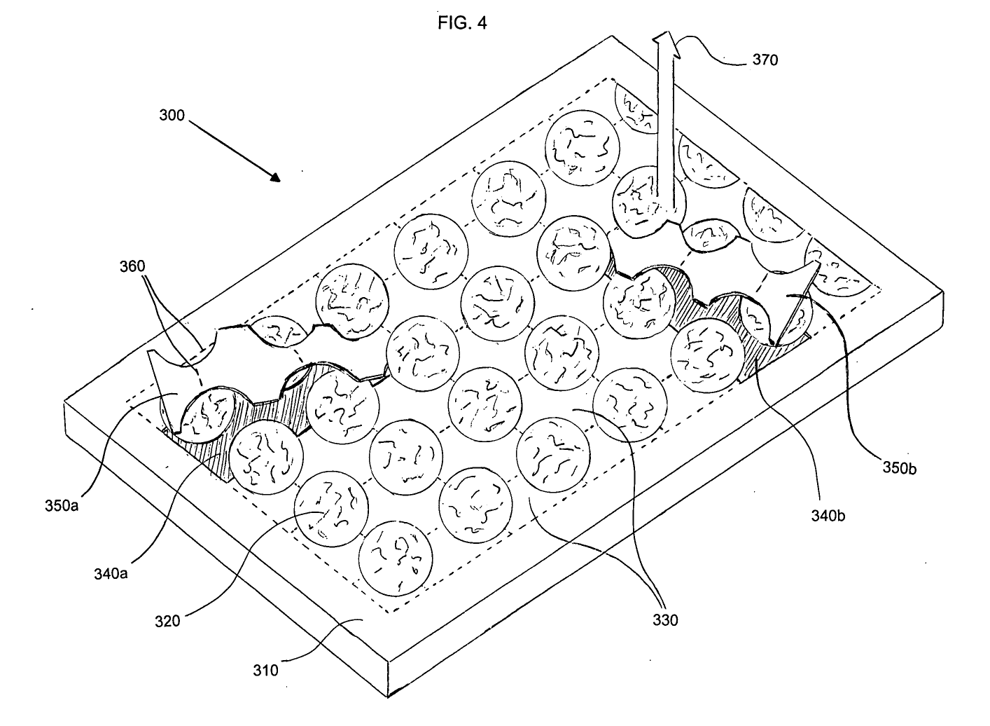

With further reference to the drawings, FIG. 4 depicts a perspective view of yet another embodiment of an air treatment apparatus 300, in accordance with the present invention. The air treatment apparatus 300 may have an external frame 310 integral with a grid structure 330 dually operating to support an air filter 320. The external frame 310 may be dimensioned to fit standard forced air treatment system components and configured to retain the outer edge of the air filter 320. The air filter 320 may be configured to filter pollutants and/or odors from air. An embodiment of the air filter 320 may be an air-permeable/porous fibrous filtering material enclosed by and/or mounted in the external frame 310 working in conjunction with the grid structure 330. Various embodiments of the air filter 320 may be designed to function with various levels of filtration performance and to have varying useable life-spans of health and/or efficient filtration capability.

In continued reference to FIG. 4, the grid structure 330 may be a planar panel member substantially spanning the air filter 320 as enclosed within the external frame 310. The shape of the grid, lattice, or network of supportive members of the grid structure 330 may vary. For example, as shown, an embodiment of the grid structure 330 may comprise the rigid or semi-rigid connective portions residing around a network of circular openings through which airflow 370 may pass. It should be appreciated that embodiments of the air treatment apparatus 300 may incorporate two circular network grid structures 330 positioned on either planar surface of an applicable air filter 320 and functional with the external frame 310 to support the air filter 320. Those in the art should also recognize that the grid structure 330 may incorporate the connective portions integrally residing around variously dimensioned openings positioned variously throughout a planar surface of the air treatment apparatus 300.

The scented planar panel member or grid structure 330 may be configured to facilitate variably apportioned aromatic treatment of air, such as the air comprising airflow 370. For instance, aromatic material 340, positioned on, with or through the grid structure 330, may be masked by removable cover elements 350. The removal cover elements 350, such as elements 350a-b may be located on the grid structure 330 and may shield aromatic material 340a-b from the surrounding air preventing the dispersal of the aromatic material 340a-b into the air. The aromatic material 340a-b may correspond to a variety of scents. Accordingly, a user of the air treatment apparatus 300 may introduce a preferred amount or apportionment of scent into the air by unmasking an aromatic portion of the grid structure 330 through removal of the cover elements, such as cover elements 350a-b. Hence, if a user prefers to treat an airflow, such as airflow 370, circulating within a particular volume of air space corresponding to a building or other structure having a particular square footage, the user may take away as many removable cover elements 350 from the grid structure 330 as necessary to achieve a preferred aroma. In an embodiment of an aromatic air treatment apparatus 300 the removable cover elements 350 may be segmented and separable by perforations 360 or other similar means utilized to permit the controlled dividing of various portions of the removable cover elements 350.

With continued reference to the drawings, a method of treating air is discussed in relation to FIGS. 1-2. The air treatment method may include a step of generating an airflow 170. The airflow may be generated by a fan, a furnace system, an air conditioning system, a vacuum system or by other similar means capable of driving or pulling fluid air through an embodiment of a filtering aromatic air treatment apparatus 100 and throughout a volume of air space. The aromatic treatment apparatus 100 for forced airflow filtration may be provided as a method step of treating the air. Included as part of the aromatic treatment apparatus 100 may be an external frame 110 retaining the periphery of an air filter 120 and operating with a grid structure 130 to support the air filter 110 when the airflow 170 is forced through the aromatic treatment apparatus 100. A portion of the grid structure 130 of the aromatic treatment apparatus 100 may contain aromatic material 140 masked by removable cover elements 150. The air may be treated further by employing a method step of filtering the air by passing the airflow 170 through the air filter 120.

Moreover, the method of air treatment may include a step of introducing a preferred amount of aroma into the air by unmasking an aromatic portion of the grid structure 130 through removal of cover elements 150 according to a corresponding volume of airspace through which the airflow 170 to be treated circulates. The preferred amount of aroma may correspond to the amount of aromatic material 140 uncovered and exposed for release into the airflow 170. The introduction of a preferred amount of aroma into the air may be dictated by indicia corresponding to predetermined aroma preference relative to square footage of a structure. Hence, if a user uncovers more aromatic material 140, the level of fragrance pertinent to the aromatic treatment of air will increase. Likewise, if a user prefers to treat the air with a less potent scent, the user may uncover less aromatic material 140.

Furthermore, the method of treating air may include removing additional cover elements 150 to unmask additional portions of aromatic material 140 periodically throughout the useable life of the aromatic treatment apparatus 100 to maintain preferred aroma of the air. Thus, a user may adjust the fragrance corresponding to air treatment over time. For example, if, as time passes, the potency of scent related to the air being treated decreases, a user may simply remove an additional cover element 150 to expose more aromatic material 140 and strengthen the potency of scent back up to the user's preferred fragrance level. Periodic removal of cover elements 150 may be dictated by indicia corresponding to predetermined aroma preference relative to the useable life of the aromatic treatment apparatus 100, such as a scented air filtration apparatus. When the additional aromatic material 140 remains shielded by the grid structure 130 and removable cover elements 150, the aromatic material 140 retains its effective fragrant potency for later delivery, if needed, and unmasked by a desiring user. Thus the method provides a user with temporal fragrance maintenance capability using an aromatic treatment apparatus that may be readily adaptable for use with common air treatment systems.

With further reference to the drawings, an additional method of treating air is discussed in relation to FIGS. 3-4. The additional air treatment method may include a step of generating an airflow 270. The airflow 270 may be generated by a fan, a furnace system, an air conditioning system, a vacuum system or by other similar means capable of driving or pulling fluid air through an embodiment of a scented air filtration apparatus 200 and throughout a volume of air space. The scented air filtration apparatus 200 may be provided as a method step of treating the air. Included as part of the scented air filtration apparatus 200 may be an air filter 220 mounted in an external frame 210 working in conjunction with a scented planar panel member 230 to support the air filter 220 when engaged by airflow 270. The planar panel member 230 may be scented with aromatic material 240 and configured such that removable cover elements 250 may be variably stripped away to expose aromatic material 240 for fragrant release into and treatment of the airflow 270. The scented planar panel member 230 (or 330 as shown in the embodiment depicted in FIG. 4) may comprise the connecting integral structure residing between a network of openings such as circles or other varied shapes though which the airflow 270/370 might pass. The introduction of a preferred amount of aroma into the air may be dictated by indicia corresponding to predetermined aroma preference relative to square footage of a structure. Indicia may be provided to assist in the variable apportionment of aromatic treatment, wherein the indicia may correspond to generalized data relating to predetermined fragrant potencies pertaining to air volumes associated with particular square footages or time periods of air treatment. Additionally, the method of air treatment may include a step of filtering the air by passing the airflow 270 through the air filter 220.

A preferred aroma may be obtained by performing the method step of scenting the air according to aroma preference in relation to the volume of space through which the airflow 270 circulates by variably apportioning the aromatic treatment of the air flow 270. Variable apportionment may be accomplished through uncovering enough removable cover elements 250 to expose enough aromatic material 240 to permeate the airflow 270 with a preferred fragrance associated with air being treated. Moreover, the air may be variably treated over time by employing the method step of adjusting the variable apportionment of aromatic treatment of the airflow 270 throughout the useable life of the scented air filtration apparatus 200 to sustain the preferred aroma of the air. This variable treatment may be accomplished by monitoring the potency level of scent pertinent to the air treatment over time, and, if the potency weakens to a level that is undesirable, exposing additional aromatic material 240 by removing additional cover elements 250 to introduce more fragrance into the airflow 270 thereby strengthening the scent back to a preferred potency. Moreover, indicia may dictate when to expose additional aromatic material to sustain a predetermined fragrant potency level. It should be recognized that the step of adjusting the variable apportionment of aromatic treatment of the airflow 270 may be repeated as often as necessary while during the useable life of the scented air filtration apparatus 200. Thus, as long as the apparatus 200 is capable of properly filtering air, scenting air and ultimately treating the airflow 270, variable apportionment of aromatic treatment is available to enhance air treatment according to preference.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A scented air filtration apparatus comprising:
an external frame;
an air filter, mounted in the frame; and,
a grid structure, operating with the frame to support the air filter,
wherein at least a portion of the grid structure contains aromatic material masked by removable cover elements.

2. The scented air filter apparatus of claim 1, wherein the removable cover elements are segmented and separable according to predetermined aroma potency.

3. The scented air filtration apparatus of claim 2, wherein the predetermined aroma potency corresponds to a particular square footage of a structure.

4. The scented air filtration apparatus of claim 2, wherein the predetermined aroma potency corresponds to an effective time period of useable scent related to a portion of aromatic material exposed by unmasking a removable cover element.

5. The scented air filtration apparatus of claim 2, wherein the separable segments of the removable cover elements correspond to indicia relative to the predetermined aroma potency.

6. The scented air filtration apparatus of claim 1, wherein the air filter is a pad of air-permeable fibrous filtering material having a peripheral edge bordered by the external frame.

7. The scented air filtration apparatus of claim 1, wherein the apparatus is dimensionally compatible with a standard forced air furnace unit.

8. The scented air filtration apparatus of claim 1, wherein the aromatic material corresponds to a variety of scents.

9. An aromatic treatment apparatus for forced airflow filtration comprising:
an air filter;
an external frame, retaining the periphery of the air filter; and,
a scented planar panel member, supporting the air filter in conjunction with the external frame,
wherein the scented planar panel member is configured to facilitate variably apportioned aromatic treatment of an airflow.

10. The aromatic treatment apparatus of claim 9, wherein the configuration of the scented planar panel member is such that a scent thereof is shielded until a portion of the shielding is uncovered.

11. The aromatic treatment apparatus of claim 10, wherein particular portions of the shielding are variably removed to effectuate various potency levels of aromatic treatment.

12. The aromatic treatment apparatus of claim 10, wherein particular portions of the shielding are variably removed over time to sustain various potency levels of aromatic treatment over time.

13. The aromatic treatment apparatus of claim 10, wherein particular portions of the shielding correspond to indicia relative to potency levels of aromatic treatment per square footage.

14. The aromatic treatment apparatus of claim 9, wherein the air filter is a pad of air-permeable fibrous filtering material having a peripheral edge bordered by the external frame.

15. The aromatic treatment apparatus of claim 9, wherein the scented planar panel member corresponds to a variety of fragrances.

16. A method of treating air comprising the steps of:
generating a forced airflow;
providing an aromatic treatment apparatus for treatment of the forced airflow, the apparatus having:
an air filter;
an external frame, retaining the periphery of the air filter; and
a grid structure, operating with the external frame to support the air filter,
wherein at least a portion of the grid structure contains aromatic material masked by removable cover elements;
filtering air by passing the forced airflow through the air filter;
introducing a preferred amount of aroma into the air by unmasking an aromatic portion of the grid structure through removal of a cover element according to a corresponding volume of airspace through which the airflow to be treated circulates; and,
removing additional cover elements to unmask additional portions of aromatic material periodically throughout a useable life of the aromatic treatment apparatus to maintain a preferred amount of aroma of the air.

17. The method of claim 16, wherein the forced airflow is generated by a fan.

18. The method of claim 16, wherein the introduction of the preferred amount of aroma of the air is dictated by indicia corresponding to a predetermined aroma preference relative to square footage of a structure.

19. The method of claim 16, wherein periodic removal of the cover elements is dictated by indicia corresponding to a predetermined aroma preference relative to the useable life of the aromatic treatment apparatus.

20. A method of treating air comprising the steps of:
generating an airflow;
providing a scented air filtration apparatus having:
an external frame;
an air filter, mounted in the external frame; and,
a scented planar panel member, supporting the air filter in conjunction with the external frame,
wherein the scented planar panel member is configured to facilitate variably apportioned aromatic treatment of the airflow;
filtering the airflow by passing the airflow through the air filter;
scenting the airflow according to an aroma preference in relation to a volume of space through which the airflow circulates by variably apportioning the aromatic treatment of the airflow; and,
adjusting the variable apportionment of aromatic treatment of the airflow throughout a useable life of the scented air filtration apparatus to sustain the aroma preference of the airflow.
